(19) United States
(12) Patent Application Publication
(10) Pub. No.: US 2016/0328759 A1
(43) Pub. Date: Nov. 10, 2016

(54) METHOD, APPARATUS, AND A NON-TRANSITORY COMPUTER-READABLE RECORDING MEDIUM FOR PROVIDING REVIEW SHARING SERVICE

(71) Applicant: NAVER CORPORATION, Seongnam-si (KR)

(72) Inventor: Jong Hyun Lee, Seongnam-si (KR)

(21) Appl. No.: 15/145,412

(22) Filed: May 3, 2016

(30) Foreign Application Priority Data
May 8, 2015 (KR) 10-2015-0064643

(51) Int. Cl. G06Q 30/02; G06Q 40/00

(52) U.S. Cl. CPC G06Q 30/0282; G06Q 40/12

(57) ABSTRACT

A method of providing a review sharing service includes: registering a post including a review of a product the post is received from a first user; and providing the post to a second user, wherein the registering includes, when the first user is a user selected as an expert reviewer based on a certain standard, registering the post including the review and first purchase information of the product by further receiving the first purchase information from the first user. The expert reviewer has authority to add purchase information of a product to a post.

### CROSS-REFERENCE TO RELATED APPLICATION

This application claims priority under 35 U.S.C. §119 to Korean Patent Application No. 10-2015-0064643 filed on May 8, 2015, in the Korean Intellectual Property Office (KIPO), the entire contents of which are incorporated herein by reference.

### BACKGROUND

1. Field

One or more embodiments of the present invention relate to a method, an apparatus, and a non-transitory computer-readable recording medium for providing a review sharing service.

2. Description of the Related Art

This section provides background information related to the present disclosure which is not necessarily prior art.

With the recent increase in supply and accessibility of communication networks, such as the Internet, cases in which a user determines whether to purchase a product or use a service after looking at other users' comments or reviews about the product or the service are increasing. For example, cases in which a user determines whether to visit a restaurant or a café after looking at reviews by other users who visited the restaurant or the café are increasing. As such, general consumers expect comments or reviews by ex-purchasers or ex-users to be more objective than those by business operators, and thus, reliability of consumers on such comments or reviews is quite high.

Accordingly, an environment in which users are able to easily and conveniently search for and check reviews is required, and requirements of users regarding reliable reviews are increasing.

### SUMMARY

This section provides a general summary of the disclosure, and is not a comprehensive disclosure of its full scope or all of its features.

One or more embodiments of the present invention include a method, an apparatus, and a non-transitory computer-readable recording medium for providing a review sharing service.

Additional aspects will be set forth in part in the description which follows and, in part, will be apparent from the description.

According to one or more embodiments, a method of providing a review sharing service includes: registering a post including a review of a product by receiving the review from a first user; and providing the post to a second user, wherein the registering includes, when the first user is a user selected as an expert reviewer based on a certain standard, registering the post including the review and first purchase information of the product by further receiving the first purchase information from the first user, and the expert reviewer has authority to add purchase information of a product to a post.

According to one or more embodiments, an apparatus for providing a review sharing service includes: a post registerer configured to register a post including a review of a product by receiving the review from a first user, and when the first user is a user selected as an expert reviewer based on a certain standard, register the post comprising the review and first purchase information of the product by further receiving the first purchase information from the first user; a post provider configured to provide the post to a second user; and an account manager configured to select the first user as the expert reviewer when the first user satisfies the certain standard, wherein the expert reviewer has authority to add purchase information of a product to a post.

According to one or more embodiments, a non-transitory computer-readable recording medium has stored thereon a computer program that when executed by a processor causes the processor to perform a method including: registering a post including a review of a product by receiving the review from a first user; and providing the post to a second user, wherein the registering includes, when the first user is a user selected as an expert reviewer based on a certain standard, registering the post including the review and first purchase information of the product by further receiving the first purchase information from the first user, and the expert reviewer has authority to add purchase information of a product to a post.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram of a system for providing a review sharing service, according to an embodiment;

FIG. 2 is a block diagram of an apparatus for providing a review sharing service, according to an embodiment;

FIG. 3 is a flowchart of a method of providing a review sharing service, according to an embodiment;

FIG. 4 is a flowchart of a method of providing a review sharing service, according to another embodiment; and

FIGS. 5 through 8 illustrate examples of screens provided by a server of FIG. 1 and displayed on a user terminal, according to embodiments.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments of the present invention will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

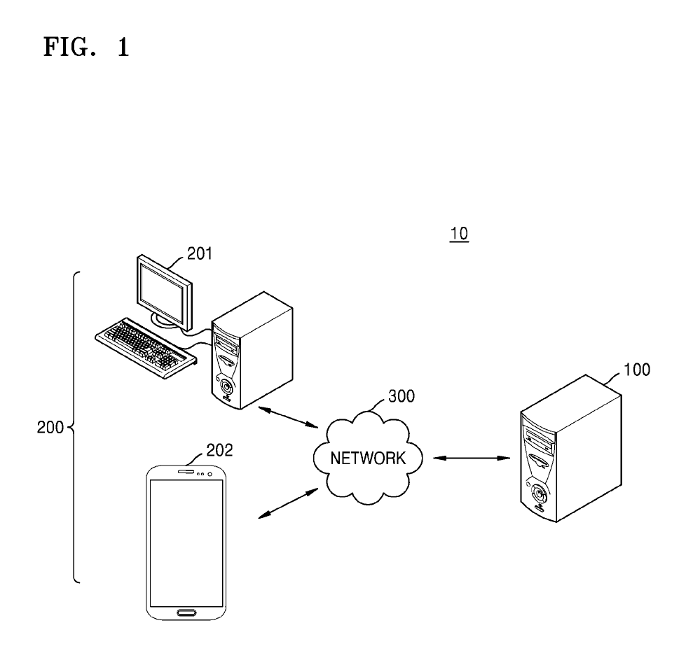

FIG. 1 is a diagram of a system 10 for providing a review sharing service, according to an embodiment.

Referring to FIG. 1, the system 10 according to an embodiment includes a server 100, a user terminal 200, and a network 300 connecting the server 100 and the user terminal 200.

The system 10 according to an embodiment provides a review sharing service. For example, the system 10 according to an embodiment provides a review preparing service for a user to prepare a review, and a review providing service for providing a review prepared by another user. The system 10 according to an embodiment registers a post including a review in the server 100 when a user uploads the post, and provides an interface for other users to look up posts registered in the server 100.

The review preparing service and the review providing service may be integrally provided by the server 100 shown in FIG. 1, but an embodiment is not limited thereto. The review preparing service and the review providing service may be provided by separate servers.

The system 10 according to an embodiment may provide an environment in which users may build a relationship with each other, and provide a social network service based on the relationship between the users. For example, the users may assign each other as friends, and the system 10 may gather and provide posts prepared by the users assigned as friends.

The system 10 according to an embodiment may gather and provide reviews prepared by one user in one page, or may list and provide reviews prepared by several users according to a certain rule in one page. Also, the system 10 may provide a page that contains detailed information of one review.

A review provided according to an embodiment may be a review of a certain product or on a point of interest (POI). Here, a POI is a term indicating a point on a map, such as a building or a store.

Users subscribed to the system 10 according to an embodiment prepare a post by using the review preparing service. The post may include a review of a certain product or a POI.

The system 10 according to an embodiment grades users and manages the authority of the users according to the grades. For example, the system 10 according to an embodiment may select a user who satisfies a pre-set condition from among users as an expert reviewer, and assign special authority to the user selected as an expert reviewer. For example, an expert reviewer would have the authority to add purchase information to a post while preparing the post including a review. When another user accesses a purchase page by selecting a link included in the purchase information, a reward may be provided to the expert reviewer.

When a target of a review is a product, purchase information may be information for directly purchasing the product, and when a target of a review is a POI, the purchase information may be information for purchasing a product sold at the POI or information for purchasing a coupon usable at the POI. A condition for selecting an expert reviewer may be based on reliability of other users.

A user may assign a tag while preparing a post including a review. The tag may be based on text, and may include a word related to a product or POI that is a target of the review. For example, while registering a post including a review of clothes of a certain brand, a user may assign text, such as “T-shirt” or “white shirt”, as a tag of the post. A tag assigned to a post is a type of metadata, and may be used in various functions, such as managing, checking, and searching for a post. Since a preparer of a post directly assigns a tag, a suitable tag without an error in terms of an actual correlation with the post and trend reflection may be assigned.

Referring to FIG. 1, the user terminal 200 is a communication terminal capable of using a web service in a wired/wireless communication environment. Here, the user terminal 200 may be a personal computer (PC) 201 of a user or a mobile terminal 202 of the user. In FIG. 1, the mobile terminal 202 is illustrated as a smart phone, but an embodiment is not limited thereto, and the mobile terminal 202 may be any terminal on which an application capable of web browsing is mounted.

The user terminal 200 includes a display displaying a screen and an input apparatus receiving data from a user. Examples of the input apparatus include a keyboard, a mouse, a track ball, a microphone, a button, and a touch panel, but are not limited thereto.

The network 300 connects the user terminal 200 and the server 100 to each other. For example, the network 300 provides an access path for the user terminal 200 to access the server 100 and transmit and receive packet data to and from the server 100.

Although not shown in FIG. 1, the server 100 according to an embodiment may include a memory, an input/output (I/O) unit, a program storage unit, and a controller.

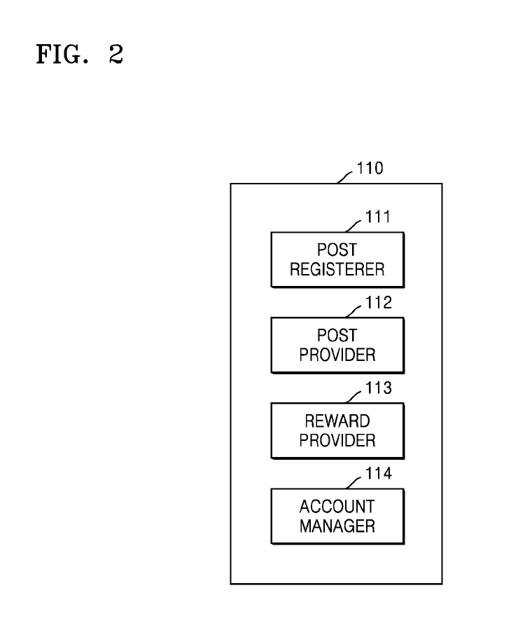

FIG. 2 is a block diagram of an apparatus 110 for providing a review sharing service, according to an embodiment.

The apparatus 110 according to an embodiment may be implemented in one processor or may include at least one processor. Accordingly, the apparatus 110 may be driven while being included in another hardware apparatus, such as a microprocessor or a general-use computer system. The apparatus 110 may be a unit or a device of the server 100 of FIG. 1.

Only components of the apparatus 110 related to the current embodiment are shown in FIG. 2 in order to prevent features of the current embodiment from being blurred. Thus, it would be obvious to one of ordinary skill in the art that the apparatus 110 may further include general-purpose components other than those shown in FIG. 2.

Referring to FIG. 2, the apparatus 110 according to an embodiment includes a post registerer 111, a post provider 112, a reward provider 113, and an account manager 114. These components or units 111, 112, 113 and 114 are functions performed by the processor, i.e., the apparatus 110. The functions of the components or units 111, 112, 113 and 114 may be implemented as computer programs including code or instructions that may be hardcoded or programmed directly in the processor, or that are stored in a separate storage medium (not shown) and retrieved and executed by the processor.

The apparatus 110 may provide a review sharing service according to an embodiment to a plurality of users. For example, the apparatus 110 may receive a post from a user, provide the post to other users, provide a reward to the user according to results of other users using the post, and manages user account information and relationships between user accounts.

Hereinafter, a first user indicates a user who prepares a post, a second user indicates a user who is provided with a post, and a third user indicates a user who is registered as a seller. However, the first through third users are separately indicated so as to distinguish objects with respect to which the apparatus 110 provides a service, and the first through third users may be one user or different users.

The post registerer 111 according to an embodiment receives a post including a review about a product from the user terminal 200 of a first user, and registers the post including the review. The post registerer 111 may further receive a tag to be used for a search of the post, from the first user. The post registerer 111 may assign the tag received from the first user as a tag of the post. Here, at least one tag may be assigned.

The post registerer 111 may further receive purchase information of the product from the first user when the first user is an expert reviewer, and register the post including the review and the purchase information. An expert reviewer is selected by the account manager 114, and a user who satisfies a certain standard is selected as the expert reviewer.

A user selected as an expert reviewer has authority to add purchase information of a product to a post. The purchase information denotes information about the product sold through a certain website, and includes a representative image, a purchase link, and price information. The second user who is looking at the post may select the purchase link included in purchase information to directly move to a purchase page, i.e., the webpage, of the product. Since adding the purchase information to the post is highly likely to be related to abusing of advertisement, the post registerer 111 assigns the authority to add the purchase information only to the posts of a user who is selected as an expert reviewer by satisfying the certain standard.

The post registerer 111 may receive purchase authentication indicating that the first user actually purchased the product that is reviewed. For example, the post registerer 111 may receive the purchase authentication indicating that the first user actually purchased the product corresponding to the purchase information, and upon receiving the purchase authentication, register the post including the review, the purchase information, and a purchase authentication mark of the product.

The first user may request a sales server (not shown) to authenticate a purchase history of the product, and the sales server may check a database to determine whether the first user actually purchased the product, and when it is determined that the first user actually purchased the product, transmit the purchase authentication to the post registerer 111. In other words, the post registerer 111 may receive the purchase authentication from the sales server. However, an embodiment is not limited thereto, and the first user may receive the purchase authentication from the sales server and transmit the purchase authentication to the post registerer 111.

Meanwhile, the third user who is looking at the post prepared by the first user may request the post registerer 111 through the user terminal 200 to post new purchase information. The third user may be a user who sells the product. For example, a product seller, i.e., the third user, may request the post registerer 111 to add purchase information of a product the third user is selling with respect to a post including a review about the product. Hereinafter, purchase information posted by the first user, i.e., a writer of the post, will now be referred to as first purchase information, and purchase information requested to be posted by the third user, i.e., a product seller, will now be referred to as second purchase information.

The post registerer 111 may receive, from the third user, the second purchase information of the product that is a target of the post prepared by the first user, request the first user for an approval of adding the second purchase information to the post, and upon receiving the approval from the first user, change registration information of the post to include the second purchase information.

In this regard, the third user may directly request the first user to post second purchase information of a product sold by the third user with respect to the post with which a lot of other users identified or to the post having many comments. For example, the third user may request the first user to post second purchase information of a product sold by the third user by pushing the “Request the first user to post purchase information” and filling out a prescribed form. Also, the third user may request the first user to post second purchase information of a product sold by the third user by leaving comments regarding a request to post second information of a product sold by third user on the post.

While requesting the first user to post the second purchase information, the third user may also transmit, to the post registerer 111, reward information about a reward given to the first user if other users access a purchase page of the product through the second purchase information, and the post registerer 111 may transmit the reward information to the first user. Then, the first user may determine whether to approve the adding of the second purchase information to the post by considering the reward information.

The post provider 112 according to an embodiment provides posts to the second user, including the posts prepared by the first user. The post provider 112 may provide, to the second user, a page that contains detailed information of one post. A page of one post may show a review included in the post, writer information, purchase information, and a purchase authentication mark.

While listing the plurality of posts, the post provider 112 may display an identifier to a post prepared by a user assigned as a first relationship with the second user, and arrange such a post at the top of the plurality of posts. The first relationship may be, for example, a type of friend relationship assigned between users subscribed to a social network service (SNS). The first and second users may be assigned as a friend relationship when the first user subscribed to the SNS requests the second user subscribed to the same SNS to form a friend relationship and the second user approves the friend relationship. The friend relationship may be managed by the account manager 114. The post provider 112 displays the identifier to the post prepared by the user assigned as the friend relationship with the second user who receives the post, thereby increasing discrimination of the post prepared by the first user assigned as the friend relationship with the second user. Also, the post prepared by the first user assigned as the friend relationship with the second user may be displayed at the top of the plurality of posts such that the second user is able to view the post prepared by the first user assigned as the friend relationship with priority.

The post provider 112 may identify the current location of the second user by receiving, from the second user, current location ID information recognized based on a beacon provided at a certain location. When listing and providing the plurality of posts, the post provider 112 may list, at the top, a post in which a selling location of a product that is a target of the post or a location of a POI that is a target of the post is closest to the current location of the second user. In this regard, the post registerer 111 may directly receive the selling location of the product or the location of the POI while the post is registered by the first user, and register the selling location of the product or the location of the POI in relation to the post.

Here, the beacon uses a short distance wireless communication method based on a Bluetooth protocol, and when a user with a user terminal 200 approaches a beacon communication device provided at a certain location, the beacon communication device recognizes the approach of the user and recognizes that the user is near the certain location where the beacon communication device is provided.

The post provider 112 may receive a post search request from the second user and provide a post search result corresponding to the post search request. For example, the post provider 112 may receive location information from the second user, and list and provide posts including reviews on products sold in a region corresponding to the location information or on POI in the region corresponding to the location information, or posts registered in relation to a location in the region corresponding to the location information. The second user may transmit the current location to the post provider 112 as the location information, or may transmit the location information irrelevant to the current location to the post provider 112.

As another example, the post provider 112 may receive, from the second user, a search request including a tag, and list and provide, to the second user, posts to which the tag is assigned. For example, the post provider 112 may receive a search request including a tag “pizza” from the second user, and list and provide posts to which the tag “pizza” is assigned to the second user. When the number of posts to which the tag is assigned is equal to or higher than a threshold value, a number of posts pre-set based on popularity may be selected and provided. Here, the post provider 112 may also list and provide, to the second user, a post including a keyword “pizza” in text of a review.

The reward provider 113 according to an embodiment provides a reward to the first user who prepared the post when the second user selects the purchase link included in the purchase information of the post. Since the second user moves to the purchase page through the purchase information of the post prepared by the first user, it may be determined that the first user induced the second user to move to the purchase page. Thus, the reward provider 113 provides the reward to the first user, and the first user may make a claim to an operator of the purchase page for a value of the reward. The reward may provided to the first user as a type of reward cash and/or reward mileage. For example, when the second user moves to the purchase page through the purchase information of the post prepared by the first user, the reward provider 113 may provide reward mileage corresponding to 1,000 won to the first user.

A claim to the operator of the purchase page may be in the form of type of cash and/or mileage as much as reward cash and/or reward mileage. For example, reward provider 113 may make a claim to the operator of the purchase page for 1,000 won.

Since the operator of the purchase page according to the current embodiment spends a type of incurs advertising costs, when the post registerer 111 receives the purchase information from the first user and registers the post including the purchase information, the post registerer 111 may perform processes of receiving an approval from the seller of the product to post the purchase information. For example, the post registerer 111 may receive the review and the purchase information from the first user, request the seller to approve the posting of the purchase information, and register the post that does not include the purchase information first. Then, when the seller approves the posting later, the post registerer 111 may additionally add the purchase information to the post.

The account manager 114 according to an embodiment manages joining, withdrawal, login, and logout, and manages account information of users. Account information includes information about whether a user is a seller or an expert reviewer. When a user is a seller, the account manager 114 may perform an operation of determining whether the user is actually a seller through authentication with the sales server. When the user is a seller, the account information may include an address of a website through which the user is selling the product and a category of the product.

The account manager 114 stores a subscription relationship between users. For example, the account manager 114 stores a list of users who subscribed to the post of the first user. When the post of the first user is newly registered or the like, the post provider 112 receives the list of users who subscribed to the post of the first user from the account manager 114, and provide the post to the users who subscribed to the post of the first user.

The account manager 114 may select a user who satisfies the certain standard as an expert reviewer, and provide special authority to the user selected as the expert reviewer. The special authority may be authority to post purchase information as described above.

Certain standards may be provided suitably to guarantee reliability of a user. According to an embodiment, the post prepared by the first user may be numerically evaluated by other users. Here, a numerical evaluation may be performed based on, for example, the number of identifications expressed by other users regarding a post, the number of comments on the post, and the number of times other users clipped the post. Also, when the other users are subscribed to posts prepared by the first user, the other users may receive a notification when the first user posts a new post or gather and look at posts prepared by the first user. The account manager 114 may select the first user as an expert reviewer when the number of posts that are evaluated as being a reference value or higher by other users is equal to or higher than a pre-set number. Alternatively, the account manager 114 may select the first user as an expert reviewer when the number of users who subscribed to posts of the first user is equal to or higher than a pre-set number. However, the standards for selecting an expert reviewer is not limited thereto.

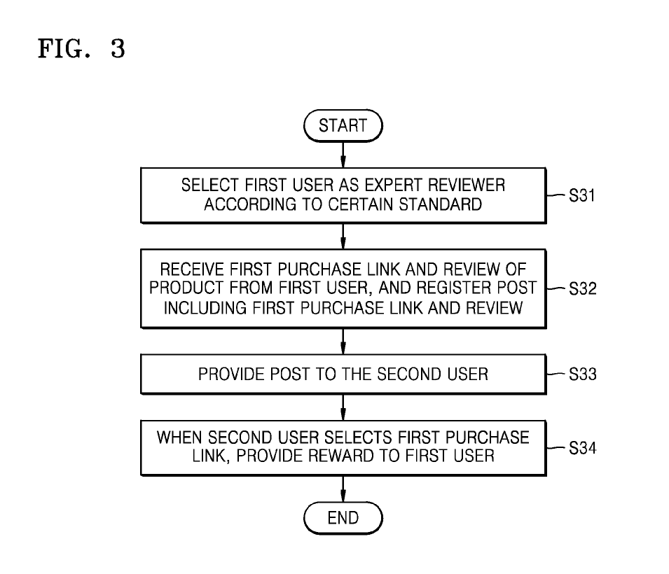

FIG. 3 is a flowchart of a method of providing a review sharing service, according to an embodiment.

The method of FIG. 3 includes operations performed in time-series by the apparatus 110 of FIG. 2. Thus, details that are described with reference to FIG. 2 are also applied to the method of FIG. 3 even if omitted.

Referring to FIG. 3, the account manager 114 of FIG. 2 selects the first user as an expert reviewer according to certain standards, in operation S31.

In operation S32, the post registerer 111 of FIG. 2 may receive a first purchase link and a review of a product or POI from the first user, and registers a post including the first purchase link and the review. In operation S32, the post registerer 111 determines that the first user is the expert reviewer, and then receives the first purchase link from the first user. The first purchase link may be a link of a website for purchasing the product or for purchasing a coupon usable at the POI.

The post registerer 111 may receive, from the first user, first purchase information including not only the first purchase link but also a representative image of the product and price information, and register the post including the first purchase information. Alternatively, the post register 111 may access the first purchase link to obtain the representative image and the price information, and then add the first purchase information including the representative image, the price information, and the first purchase link to the post.

In operation S33, the post provider 112 of FIG. 2 provides the post registered by the first user to the second user.

In operation S34, when the second user selects the first purchase link included in the post, the reward provider 113 of FIG. 2 provides a reward to the first user who prepared the post.

Meanwhile, the method of FIG. 3 is only an example, and an embodiment is not limited thereto.

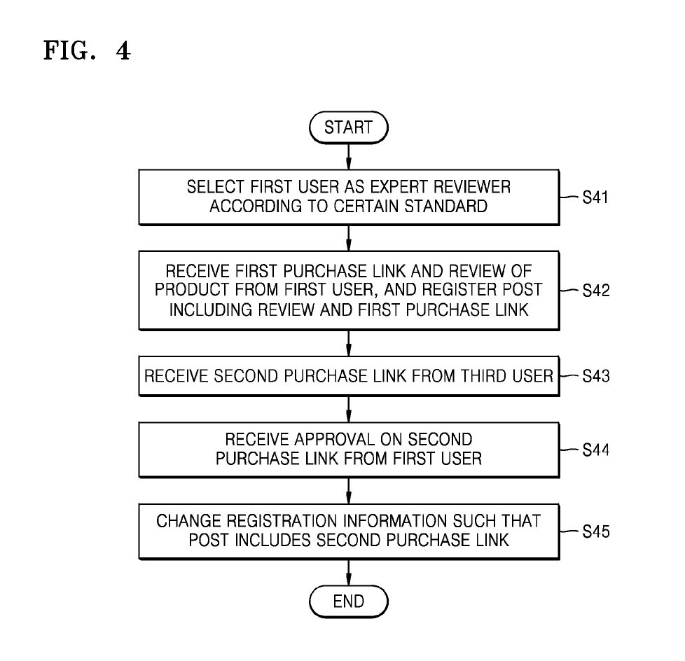

FIG. 4 is a flowchart of a method of providing a review sharing service, according to another embodiment.

The method of FIG. 4 includes operations performed in time-series by the apparatus 110 of FIG. 2. Thus, details that are described with reference to FIG. 2 are also applied to the method of FIG. 4 even if omitted.

Referring to FIG. 4, the account manager 114 of FIG. 2 selects the first user as an expert reviewer according to certain standards, in operation S41.

In operation S42, the post registerer 111 of FIG. 2 may receive a first purchase link and a review of a product or POI from the first user, and registers a post including the first purchase link and the review. In operation S42, the post registerer 111 determines that the first user is the expert reviewer, and then receives the first purchase link from the first user. The first purchase link may be a link of a website for purchasing the product or for purchasing a coupon usable at the POI.

The post registerer 111 may receive, from the first user, first purchase information including not only the first purchase link but also a representative image of the product and price information, and register the post including the first purchase information. Alternatively, the post register 111 may access the first purchase link to obtain the representative image and the price information, and then add the first purchase information including the representative image, the price information, and the first purchase link to the post.

In operation S43, the post registerer 111 of FIG. 2 receives a second purchase link about the post registered in operation S42, from the third user. Here, the third user is a seller who sells the product or the coupon usable at the POI.

The second purchase link may be a link of a website for purchasing the product or the coupon usable at the POI. In operation S43, the post registerer 111 of FIG. 2 may determine that the third user is an operator of the website connected to the second purchase link or the seller of the product sold in the website connected to the second purchase link, and then receive the second purchase link from the third user and perform operation S44.

For example, the post registerer 111 may determine whether the third user is registered as the seller from account information stored in the account manager 114, access website information operated by the third user, and when it is determined that the website information matches website information included in the second purchase link, perform operation S44.

The post registerer 111 may receive second purchase information including not only the second purchase link, but also a representative image and price information of the product, from the third user. Alternatively, the post registerer 111 may obtain the representative image and the price information by accessing the second purchase link, and then obtain the second purchase information including the representative image, the price information, and the second purchase link.

In operation S44, the post registerer 111 requests the first user to approve posting of the second purchase link, and receives an approval from the first user. Since the third user desires to add the second purchase link to the post prepared by the first user, the third user requests for the approval from the first user. When the first user approves to add the second purchase link to the post, operation S45 is performed.

In operation S45, the post registerer 111 changes the registration information such that the post prepared by the first user includes the second purchase link added by the third user. Then, when the second user accesses the website linked to the second purchase link by selecting the second purchase link, the first user receives a reward and claims from the third user compensation in the form of money, product or service corresponding to the value of the reward.

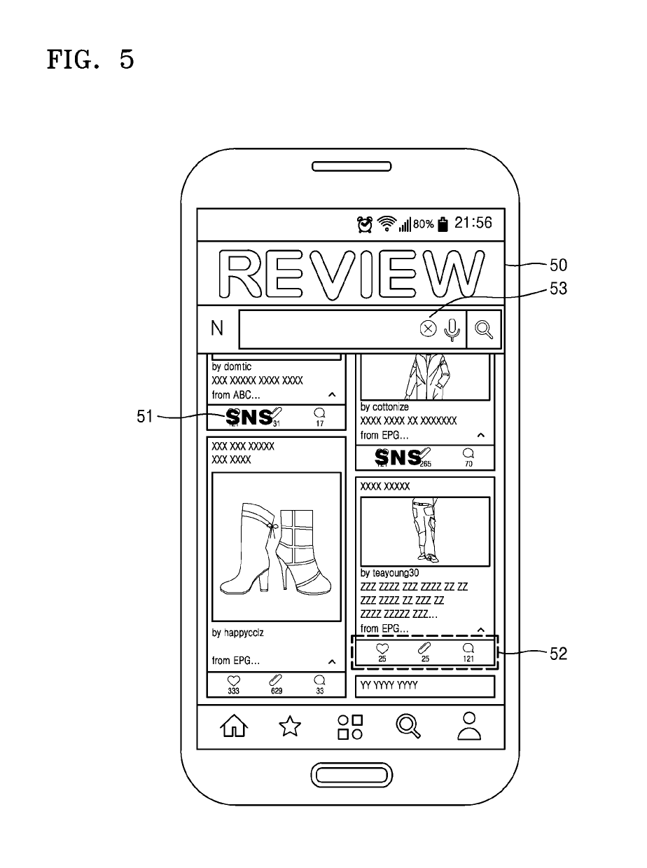

FIGS. 5 through 8 illustrate examples of screens provided by the server 100 of FIG. 1 and displayed on the user terminal 200, according to embodiments. Functions of the apparatus 110 of FIG. 2 will now be described with reference to FIGS. 5 through 8.

First, FIG. 5 shows an example of a screen 50 provided by the post provider 112 of FIG. 2.

The screen 50 of FIG. 5 is provided when the second user first accesses a page of the review sharing service provided according to an embodiment. Referring to FIG. 5, the screen 50 lists posts prepared by a plurality of users. The posts may be listed in two columns as in the screen 50, but an arrangement of the posts is not limited thereto.

In the screen 50, an identifier 51 is displayed on a post prepared by a user assigned as a friend relationship with the second user who is provided with the screen 50. The identifier 51 may be differently displayed based on a relationship between the second user and a writer of a post. In FIG. 5, the identifier 51 of ‘SNS’ is displayed since the writer of the post and the second user have a friend relationship through an SNS.

Each post includes a region 52 displaying identification, comments, and clipping information of other users. When a user viewing a post identifies with contents of the post, the user may add an identification mark, clip the post to his/her personal webpage, or leave a comment regarding the post. The numbers of identifications and comments, and the number of times the post is clipped are displayed in the region 52. A user who prepared a post that is identified by other users at least a certain number of times, that has at least a certain number of comments, or that is clipped at least a certain number of times may be selected as an expert reviewer by the account manager 114.

The screen 50 may include a search window 53. The second user may input a search word into the search window 53, and the post provider 112 may gather posts corresponding to the search word and provide the posts to the second user. The post corresponding to the search word may include the search word in text, include the search word as a tag, or be registered in relation to a location information related to the search word. For example the second user may input “Soho” that is a certain location, and the post provider 112 may list and provide, to the second user, posts that include “Soho” in text, assign “Soho” as a tag, and includes location information of “Soho”.

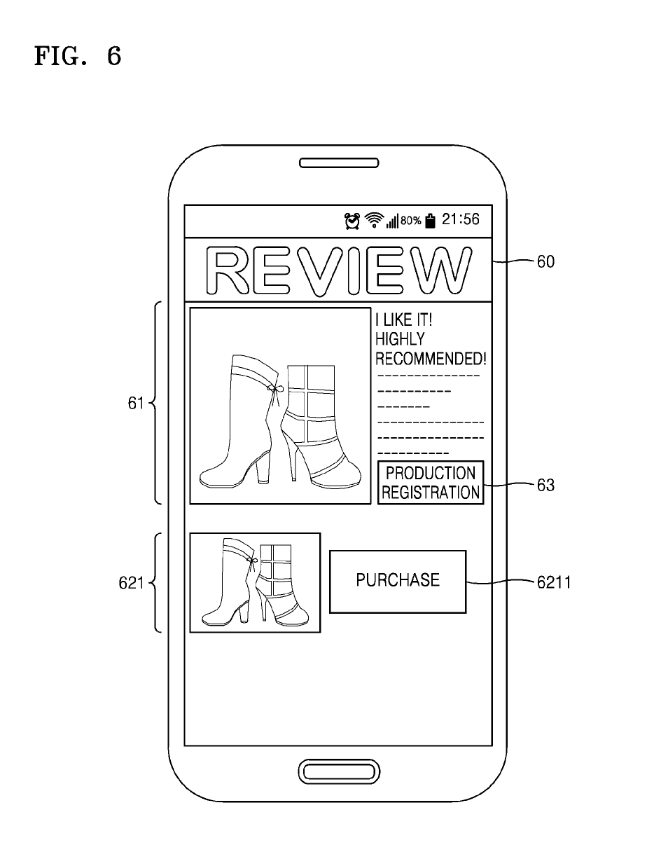

FIG. 6 shows another example of a screen 60 provided by the post provider 112.

The screen 60 of FIG. 6 is an example of an end page of a post uploaded by the first user. For example, the screen 60 of FIG. 6 is displayed when the second user selects a shoe-related post at the left bottom of the screen 50 of FIG. 5.

Referring to FIG. 6, the screen 60 includes a review 61 and purchase information 621. The review 61 includes an image directly attached by the first user who is a writer and text directly written by the first user, and the purchase information 621 includes a representative image and a purchase link of a product that is a target of the review. Although not shown in the screen 60, the purchase information 621 may further include a price of the product. The second user may move to a webpage corresponding to the purchase link by selecting a purchase icon 6211, and in this case, the first user receives a reward.

Meanwhile, the third user who is a seller of the product may also view posts prepared by other people, and may select a product registration icon 63 to request the first user to post purchase information of a different product sold by the third user with respect to the post in the screen 60. Hereinafter, purchase information posted by the first user will be referred to as first purchase information and purchase information requested to be posted by the third user will be referred to as second purchase information.

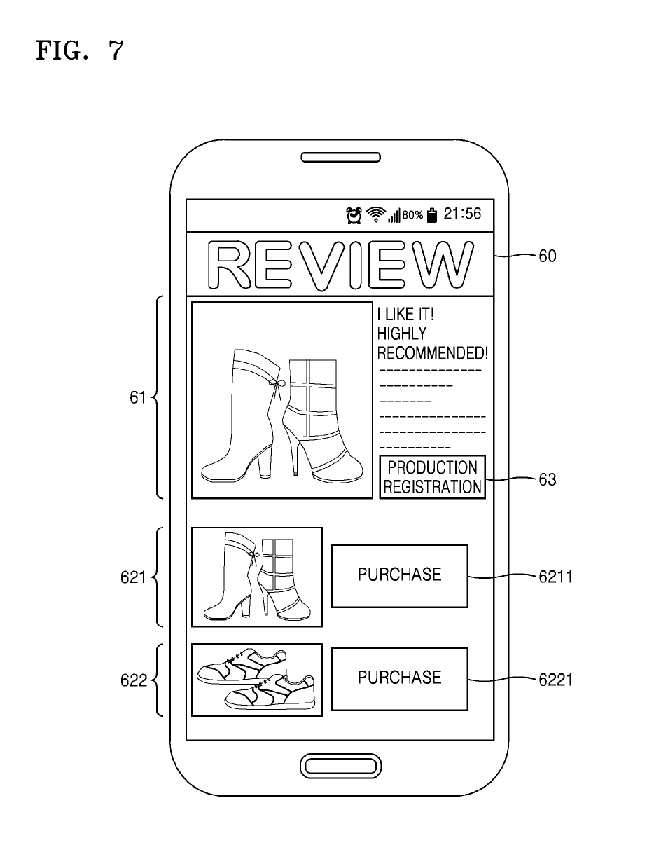

FIG. 7 shows another example of the screen 60 provided by the post provider 112 of FIG. 2.

For example, the screen 60 of FIG. 7 is an example of an end page displayed when the third user inputs second purchase information by selecting the product registration icon 63 of FIG. 6, and the post registerer 111 requests the first user to approve posting of the second purchase information, receives an approval from the first user, and changes registration information of the post to include the second purchase information.

The screen 60 of FIG. 7 further includes second purchase information 622 compared to the screen 60 of FIG. 6. The second user may select a purchase icon 6221 to move to a webpage corresponding to a purchase link included in the second purchase information 622, and in this case, the first user receives a reward. The first user may claim the third user who requested to post the second purchase information 622 for money or reward mileage corresponding to a value of the reward.

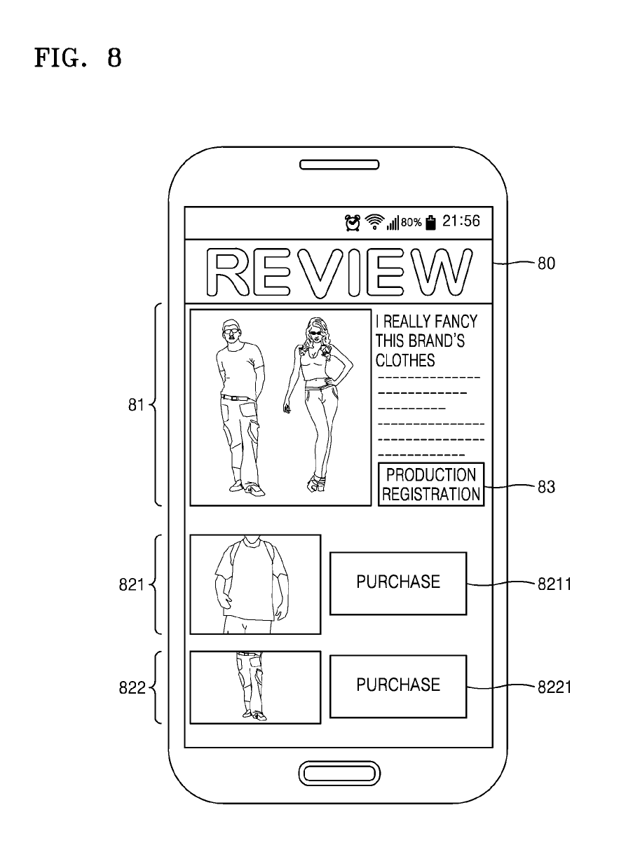

FIG. 8 shows another example of a screen 80 provided by the post provider 112 of FIG. 2.

The screen 80 of FIG. 8 is another example of an end page of one post uploaded by the first user. The post displayed on the screen 80 includes a review 81 on a plurality of products, unlike the post in the screen 60 of FIGS. 6 and 7. The reviews 81 include an image and text with respect to the plurality of products. For example, the review 81 may include evaluation on a T-shirt and trousers in the image.

Purchase information at the bottom of the review 81 may include purchase information for each of the plurality of products. In the screen 80, T-shirt purchase information 821 and trousers purchase information 822 are displayed. As such, when one post includes purchase information of a plurality of products, the purchase information may include a plurality of purchase links.

For example, the T-shirt purchase information 821 may include a representative image of the T-shirt, a plurality of purchase links, and price information sold in a webpage accessible through each purchase link. When the second user selects a purchase icon 8211, the second user may move to a purchase link having a priority according to a certain condition from among the plurality of purchase links included in the T-shirt purchase information 821. For example, the second user may select the purchase icon 8211 and move to a purchase link of a webpage selling the T-shirt at the cheapest price.

Similarly, the trousers purchase information 822 may include a representative image of the trousers, a plurality of purchase links, and price information sold in a webpage accessible through each purchase link. When the second user selects a purchase icon 8221, the second user may move to a purchase link having a priority according to a certain condition from among the plurality of purchase links included in the trousers purchase information 822. For example, the second user may select the purchase icon 8221 and move to a purchase link of a webpage selling the trousers at the cheapest price.

The third user may select a product registration icon 83 to request the first user to post new purchase information of another product or to add a new purchase link to the first or existing purchase information in the post. The request of the third user is transmitted to the first user, and when the first user approves the request, the new purchase information or the new purchase link may be added to the post.

According to a method, apparatus, and computer program for providing a review sharing service according to one or more embodiments, additional authority is provided to a user recognized as an expert reviewer to provide a high quality review sharing service based on reliability.

According to a method, apparatus, and computer program for providing a review sharing service according to one or more embodiments, purchase information is provided together with a review, and when a purchase website is accessed through the purchase information, a reward is provided to a user who posted the purchase information, thereby motivating the user to prepare and provide a reliable review.

The embodiments may be written as computer programs and may be implemented in digital computers that execute the programs using a non-transitory computer-readable recording medium. Examples of the non-transitory computer-readable recording medium include magnetic storage media (e.g., ROM, floppy disks, hard disks, etc.), optical recording media (e.g., CD-ROMs, or DVDs), etc.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method, performed by a processor, of providing a review sharing service in a communication network, the method comprising:
registering a post including a review of a product when the post is received from a user terminal of a first user; and
providing the post to a user terminal of a second user,
wherein when the first user is selected as an expert reviewer based on a certain standard, further receiving first purchase information from the first user and registering the post including the review and the first purchase information of the product, and
wherein the expert reviewer has authority to add the purchase information of the product to the post.

2. The method of claim 1, wherein the providing comprises listing a plurality of posts including the post prepared by the first user, and displaying an identifier to a post prepared by a user having a first relationship with the second user from among the plurality of posts.

3. The method of claim 1, wherein the providing of the post comprises listing a plurality of posts including the post prepared by the first user,
wherein a current location of the second user is identified by receiving current location identification (ID) information recognized based on a beacon, from the user terminal of the second user, and from among the plurality of posts, a post in which a selling location of a product that is a target of the post is closest to the current location of the second user is listed at a top of the listing of the plurality of posts.

4. The method of claim 1, wherein the providing comprises receiving location information from the second user, and listing at least one post including a review of a product sold in a region corresponding to the location information.

5. The method of claim 1, wherein the registering further comprises further receiving, from the first user, a tag to be used to search for the post, and assigning the received tag to the post, and
the providing comprises receiving a tag from the second user and listing at least one post to which the received tag is assigned.

6. The method of claim 1, wherein the registering further comprises receiving purchase authentication indicating that the first user purchased the product from a sales server, and upon receiving the purchase authentication, registering the post including the review, the first purchase information, and a purchase authentication mark.

7. The method of claim 1, further comprising, after the providing of the post, when the second user selects a purchase link included in the first purchase information of the product, providing a reward to the first user.

8. The method of claim 1, further comprising, before the registering of the post, selecting the first user as an expert reviewer when a number of posts that received an evaluation equal to or higher than a reference value from another user from among posts prepared by the first user is equal to or higher than a pre-set number or when a number of users who subscribed to a post of the first user is equal to or higher than a pre-set number.

9. The method of claim 1, further comprising, after the registering:
receiving, from a third user, second purchase information of the product that is a target of the post prepared by the first user;
receiving an approval for the second purchase information from the first user; and
changing registration information of the post such that the post comprises the second purchase information.

10. An apparatus for providing a review sharing service in a communication network, the apparatus comprising:
a post registerer configured to register a post including a review of a product when the post is received from a user terminal of the first user, and when the first user is a user selected as an expert reviewer based on a certain standard, register the post including the review and first purchase information of the product by further receiving the first purchase information from the first user;
a post provider configured to provide the post to a user terminal of a second user; and
an account manager configured to select the first user as the expert reviewer when the first user satisfies the certain standard,
wherein the expert reviewer has authority to add purchase information of a product to a post.

11. A non-transitory computer-readable recording medium having stored thereon a computer program that when executed by a processor causes the processor to perform a method comprising:
registering a post including a review of a product when the post is received from a user terminal of a first user; and
providing the post to a user terminal of a second user,
wherein when the first user is a user selected as an expert reviewer based on a certain standard, further receiving first purchase information from the first user and registering the post including the review and the first purchase information of the product, and
wherein the expert reviewer has authority to add purchase information of a product to a post.
